(19) United States
(12) Patent Application Publication
(10) Pub. No.: US 2022/0189338 A1
(43) Pub. Date: Jun. 16, 2022

(54) ENGLISH LEARNING PROVIDING METHOD

(71) Applicant: Kwang Joon PAK, Pyeongtaek-si (KR)

(72) Inventor: Kwang Joon PAK, Pyeongtaek-si (KR)

(21) Appl. No.: 17/594,267

(22) PCT Filed: Apr. 9, 2020
(86) PCT No.: PCT/KR2020/004863

§ 371 Date: Oct. 8, 2021

(30) Foreign Application Priority Data
Apr. 10, 2019 (KR) 10-2019-0041708

(51) Int. Cl. G09B 19/06; G06F 3/0482; G09B 5/02

(52) U.S. Cl. CPC G09B 19/06; G09B 5/02; G06F 3/0482

(57) ABSTRACT

Provided is an English learning providing method comprising: enumerating and outputting a plurality of indicators representing each constituent element of a sentence in order to compensate for weakness in sentence structurization ability, caused by conventional word-focused-only memorization, and increase understanding for the entire sentence; outputting specific example sentences corresponding to the plurality of indicators, wherein a constituent element corresponding to at least one indicator from among the plurality of indicators is outputted as a blank; and receiving, in the blank, an expression including at least one word.

### TECHNICAL FIELD

The present invention relates to an English learning providing method.

### BACKGROUND ART

Conventional English learning mainly involves simply memorizing words. When a person learns English by simply memorizing words, it is difficult to immediately express a sentence even with the memorized words. Therefore, a method is frequently used in which words and parts of speech corresponding to the words are memorized to make a sentence from the memorized words and words are configured to make a sentence according to a suitable arrangement of the parts of speech for a sentence formation. However, the name of each part-of-speech expressed on the basis of Chinese characters is not intuitive and thus is difficult for learners to understand, which lowers the motivation to learn.

In addition, the learning method of making a sentence using parts of speech involves determining the enumeration order of parts of speech according to the structure of a sentence as well as the meaning of the sentence and arranging suitable words for the meaning and the order of parts of speech. Accordingly, the rules are complicated, and there are many words to be combined. Therefore, the learning method does not help much in practicing immediate sentence construction.

### DISCLOSURE

### Technical Problem

The present invention is directed to resolving the above-described problem, that is, a learner's difficulty in making a sentence from memorized words during an English learning process.

The present invention is also directed to resolving learning results stored in short-term memory and boredom caused by simple memorization learning in the case of memorizing English words or sentences.

### Technical Solution

One aspect of the present invention provides an English learning providing method.

The English learning providing method includes enumerating and outputting a plurality of indicators representing each constituent element of a sentence, outputting a specific example sentence corresponding to the plurality of indicators while outputting a constituent element corresponding to at least one of the plurality of indicators as a blank, and receiving an expression including at least one word in the blank.

Another aspect of the present invention provides an English learning providing method including outputting a preset example sentence, outputting a plurality of indicators representing each constituent element of the sentence, and receiving matches between each constituent element of the example sentence and the plurality of indicators.

### Advantageous Effects

The present invention has the following effects.

According to at least one of embodiments of the present invention, it is possible to minimize reluctance in English learning by learning and expressing English as a language rather than for study.

According to at least one of embodiments of the present invention, it is possible to immediately and naturally make a sentence from learned words.

According to at least one of embodiments of the present invention, it is possible to easily make and express a sentence by storing a plurality of enumerated words as one unit in long-term memory.

According to at least one of embodiments of the present invention, it is possible to effectively express many sentences by combining a plurality of learned units.

According to at least one of embodiments of the present invention, unlike conventional memorization, learning is performed in various ways. Accordingly, it is possible to help storage in long-term memory and attract a learner's interest.

The additional applicable range of the present invention will become apparent from the following detailed description. However, various alterations and modifications within the spirit and scope of the present invention can be clearly understood by those skilled in the corresponding technical field, and thus the detailed description and specific embodiments such as exemplary embodiments of the present invention should be understood as mere examples.

### DESCRIPTION OF DRAWINGS

FIG. 1 shows an example of one scene of English learning related to the present invention.

FIG. 2 shows an example of one scene of English learning related to the present invention.

FIG. 3 shows an example of one scene of English learning related to the present invention.

FIG. 4 shows an example of one scene of English learning related to the present invention.

FIG. 5 shows an example of one scene of English learning related to the present invention.

FIG. 6 shows an example of one scene of English learning related to the present invention.

FIG. 7 shows an example of one scene of English learning related to the present invention.

FIG. 8 shows an example of one scene of English learning related to the present invention.

FIG. 9 shows an example of one scene of English learning related to the present invention.

FIG. 10 shows an example of one scene of English learning related to the present invention.

### MODES OF THE INVENTION

Hereinafter, embodiments disclosed in this specification will be described in detail with reference to the accompanying drawings. Regardless of reference signs, like components are assigned like reference numerals, and overlapping descriptions thereof will be omitted. The suffixes “module” and “unit” for components used in the following description are given or interchangeably used in consideration of only the ease of drafting the specification and do not have a meaning or role distinct from each other. Also, in describing the embodiments disclosed herein, detailed description of a related known art will be omitted when it is determined that the detailed description may obscure the gist of the embodiments disclosed herein. The accompanying drawings are only for easy understanding of the embodiments disclosed herein, and the technical spirit disclosed herein are not limited by the accompanying drawings. It should be understood that the present invention includes all modifications, equivalents, and substitutions within the spirit and technical scope of the present invention.

An English learning providing method described in the present invention may be implemented through devices such as a smart phone and a computer. Such an English learning providing device executes software including the English learning providing method of the present invention. The software including the English learning providing method of the present invention may be written in a language which is readable by the English learning providing device. The software including the English learning providing method may be implemented in the form of a non-transitory recording medium or a program which is downloadable, copyable, or the like.

Descriptions are based on the assumption that the English learning method of the present invention is performed in the form of a program on a device with a display. However, the present invention is not necessarily limited thereto, and characteristics of the present invention may also be applied to offline classes, online classes, textbooks and handouts used in each class, board games, and the like.

To solve the problems of the conventional English learning method, the present invention proposes the concept of a plurality of sentence element indicators constituting a sentence according to the form of the sentence and the concept of a unit verb corresponding to any one of the sentence element indicators.

A sentence element indicator is an indicator representing a constituent element of a sentence. Therefore, a plurality of constituent elements constituting a sentence may be represented by a plurality of indicators. Through a plurality of sequentially enumerated sentence element indicators, a learner may expect in what combination and order of constituent elements a corresponding sentence is made and thus what form and meaning the corresponding sentence has. Sentence element indicators play similar roles as conventional parts of speech which represent sentence constituent elements. However, there are differences in that parts of speech have non-intuitive names, such as subject, verb, object, and article, and one part of speech corresponds to one word.

Although there are such differences between sentence element indicators and parts of speech, the terms including subject, verb, and object will be used to facilitate understanding of the present invention.

For example, in the case of a declarative sentence, a sentence element indicator corresponding to a subject, a sentence element indicator corresponding to a verb, and a sentence element indicator corresponding to an object may be sequentially arranged. Each indicator may be shown as “1,” “2,” or “3.” Needless to say, the indicators may be shown as “subject,” “verb,” and “object,” but it is preferable to show the indicators in the former simple way of expression.

Sentence element indicators are expressed together with an actual sentence and repeatedly learned. Through such learning, a learner may make a habit of thinking about the structure of a sentence.

A configuration or arrangement of sentence element indicators may vary according to the form of a sentence. For example, when making an interrogative sentence including an interrogative while sentence element indicators representing a declarative sentence are output, a sentence element indicator representing the interrogative may be added in front of the existing sentence element indicators.

A unit verb means a set of at least one word including a verb. One unit verb set may include a plurality of verb concepts related to a verb having one meaning. Conventionally, as the part of speech “verb,” the bare infinitive, the past tense, and the past participle of a verb having one meaning are memorized in one set. However, a unit verb of the present invention is defined as a set of words including the present tense, the past tense, and the past participle of a verb having one meaning or all lists of words which are in front of, behind, or both in front of and behind one of the bare infinitive (present tense) and the past participle of the verb among the three forms to give additional meanings. For example, a unit verb corresponding to “go” having the meaning “move” may be not only “go,” “went,” and “gone” but also “will go,” “don't go,” “may go,” “can go,” “be going,” and the like. Unit verbs may include 194 or more unit verbs in addition to the bare infinitive, the past tense, and the past participle of a verb. In general, the set of unit verbs has a certain regularity and thus is easy to master and apply, helping a learner to improve his or her vocabulary.

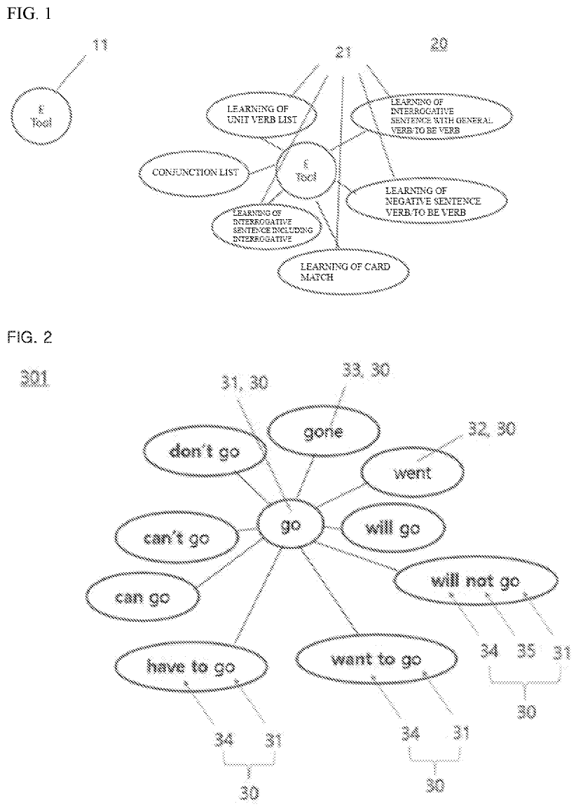

FIG. 1 shows an example of one scene of English learning related to the present invention.

The English learning providing method of the present invention may be started by executing a command for an execution icon 11. As an example, the execution icon 11 may have an icon shown as “English Tool; E Tool.” The command for the execution icon 11 may be executed in a click, double click, or drag and drop manner.

When the execution icon 11 is executed, a list 21 which is executable through the program may be enumerated. The executable list 21 may be a list classified by sentence form or may include a list according to the type of a verb or a unit verb. For example, a list of “learning of unit verb list,” “learning of interrogative sentence with general verb or to be verb,” “learning of interrogative sentence including interrogative,” “learning of negative sentence verb or to be verb,” “learning of card match,” etc. may be enumerated. The executable list 21 may be output in the form of a sequential list or output in a tree form 20 as shown in FIG. 1. When the executable list 21 is output in the tree form 20, it is easy to be aware of the progress of learning performed in each domain or stage. Accordingly, a learner can be aware of in which domain his or her learning has progressed and the like, which may help the learner to establish a future learning plan. Also, when a completed learning method or learning stage provides an interface in a form newly added to the tree form 20, the learner may gradually expand the application power by constructing an English expression using the learned learning method or the like.

Also, the tree form 20 may be simultaneously output with a learning screen. Accordingly, whenever the learner advances beyond a current stage of learning and requires additional application or whenever the learner tries to perform another learning stage during learning, the additional application or the other learning stage may be immediately performed.

Here, outputs of previous learning stages may also be outputs in a form other than the tree form 20.

The executable list 21 may be executed by a touch input for the list 21. The touch input includes a click, double clicks, or the like.

FIG. 2 shows an example in which a set of unit verbs 30 related to the present invention is shown in a tree form 301.

A unit verb 30 means a word corresponding to a sentence element indicator representing a verb in a sentence structure. In other words, a word which may be at a verb position in a sentence is a unit verb.

The unit verb 30 may include not only a bare infinitive verb 31, a past tense verb 32, and a past participle verb 33 of a specific verb but also a verb qualifier 34, which includes at least one word and qualifies the specific verb to add an additional meaning to the original meaning of the specific verb, and a negative qualifier 35 which adds a negative meaning.

In particular, the verb qualifier 34 may include verb-qualifying words, which are auxiliary verbs, such as “can” and “will,” and also single words qualifying a specific verb (which may correspond to general auxiliary verbs), and verb-qualifying phrases which have two or more words, such as “want to” or “be able to,” qualifying a specific verb. A verb-qualifying phrase may have a meaning of a causative verb, a perception verb, etc., and in this case, a verb of the unit verb 30 may be the infinitive or the past participle or may have the form “verb+ing.” In particular, when the verb has a meaning of a causative verb or a perception verb, the verb may include an object having a meaning of “who,” which may be replaced with another noun.

The bare infinitive verb 31, the past participle verb 33, the verb qualifier 34, and the negative qualifier 35 are combined with each other to generate a specific meaning in addition to the original meaning of a specific verb.

Table 1 below shows a list of 194 meanings among unit verbs 30 which may be generated as combinations of the bare infinitive verb 31, the past participle verb 33, the verb qualifier 34, and the negative qualifier 35.

TABLE 1

| | |
|---|---|
| 1. Want to (wants to) 2. Wanted to 3. Don't | 115. Be + V + ing (am + V + ing, is + V + |
| want to (doesn't want to) 4. Didn't want to | ing, are + V + ing) 116. Be not ing |
| 5. Have to (has to) 6. Had to 7. Will have to | (am not + V + ing, is not + V + ing, are |
| 8. Don't have to (doesn't have to) 9. Didn't | not + V + ing) 117. Was/Were + V + ing |
| have to 10. Won't have to 11. Get to (gets | 118. Was not/Were not + V + ing 119. |
| to) 12. Got to 13. Will get to 14. Don't get | Will be + V + ing 120. Will not be + V + |
| to (doesn't get to) 15. Didn't get to 16. | ing 121. Can be + V + ing 123. Cannot |
| Won't get to 17. Try to (tries to) 18. Tried | be + V + ing 124. Be going to (am going |
| to 19. Will try to 20. Don't try to (doesn't | to, is going to, are going to) 125. Be not |
| try to) 21. Didn't try to 22. Won't try to 23. | going to (am not going to, is not going |
| Try not to 24. Tried not to 25. Used to 26. | to, are not going to) 126. Was/Were |
| Didn't used to 27. Make + Who + Verb | going to 127. Was not/Were not going to |
| (makes + Who + Verb) 28. Made + Who + | 138. Will be going to 139. Will not be |
| Verb 29. Will make + Who + Verb 30. Can | going to 140. Can be going to 141. |
| make + Who + Verb 31. Don't make + Who + | Cannot be going to 142. Be able to (am |
| Verb (doesn't make + Who + Verb) 32. | able to, is able to, are able to) 143. Be |
| Didn't make + Who + Verb 33. Won't make + | not able to (am not able to, is not able to, |
| Who + Verb 34. Can't make + Who + | are not able to) 144. Was/Were able to |
| Verb | 145. Was not/Were not able to 146. Will |
| | be able to 147. Will not be able to 148. |
| | Can be able to 149. Cannot be able to |
| | 150. Be supposed to (am supposed to, is |
| | supposed to, are supposed to) 151. Be |
| | not supposed to (am not supposed to, is |
| | not supposed to, are not supposed to) |
| | 152. Was/Were supposed to |
| 35. Let + Who + Verb (lets + Who + Verb) | 153. Was not/Were supposed to 155. Be |
| 36. Let + Who + Verb (Present/Past) 37. | trying to (am trying to, is trying to, are |
| Will let + Who + Verb 38. Can let + Who + | trying to) 156. Be not trying to (am not |
| Verb 39. Don't let + Who + Verb (doesn't | trying to, is not is not trying to, are not |
| let + Who + Verb) 40. Didn't let + Who + | trying to) 157. Was/Were trying to 158. |
| Verb 41. Won't let + Who + Verb 42. Can't | Was not/Were not trying to 159. Will be |
| let + Who + Verb 43. Have + Who + Verb | trying to 160. Will not be trying to 161. |
| (has + Who + Verb) 44. Had + Who + Verb | Can be trying to 162. Cannot be trying to |
| 45. Will have + Who + Verb 46. Can have + | 163. Be used to + V + ing (am used to + |
| Who + Verb 47. Don't have + Who + | V + ing, is used to + V + ing, are used to + |
| Verb (doesn't have + Who + Verb) 48. | V + ing) 164. Be not used to + V + ing |
| Didn't have + Who + Verb 49. Won't have + | (am not used to + V + ing, is not used to + |
| Who + Verb 50. Can't have + Who + | V + ing, are not used to + V + ing) |
| Verb 51. Hear + Who + Verb (hears + Who + | 165. Was/Were used to + V + ing 166. |
| Verb) 52. Heard + Who + Verb 53. Will | Was not/Were not used to + V + ing |
| hear + Who + Verb 54. Can hear + Who + | 167. Will be used to + V + ing 168. Will |
| Verb 55. Don't hear + Who + Verb (doesn't | not be used to + V + ing 169. Can be |
| hear + Who + Verb) 56. Didn't hear + Who + | used to + V + ing 170. Cannot be used to + |
| Verb 57. Won't hear + Who + Verb 58. | V + ing 171. Get good at + V + ing |
| Can't hear + Who + Verb 59. See + Who + | (gets good at + V + ing) 172. Got good |
| Verb (sees + Who + Verb) 60. Saw + Who + | at + V + ing 173. Will get good at + V + |
| Verb 61. Will see + Who + Verb 62. Can | ing 174. Can good at ing 175. Don't get |
| see + Who + Verb 63. Don't see + Who + | good at + V + ing 176. Didn't get good |
| Verb (doesn't see + Who + Verb) 64. Didn't | at + V + ing 177. Won't get good at + V + |
| see + Who + Verb 65. Won't see + Who + | ing 178. Can't get good at + V + ing |
| Verb | 179. Be good at + V + ing (am good at + |
| | V + ing, is good at + V + ing, are good |
| | at + V + ing) |
| 66. Can't see + Who + Verb 67. Help + | 180. Be not good at + V + ing (am not |
| Who + Verb (helps + Who + Verb) 68. | good at + V + ing, is not good at + V + |
| Helped + Who + Verb 69. Will help + Who + | ing, are not good at + V + ing) 181. |
| Verb 70. Can help + Who + Verb 71. | Was/Were good at + V + ing 182. Was |
| Don't help + Who + Verb (doesn't help + | not/Were not good at ing 183. Will be |
| Who + Verb) 72. Didn't help + Who + Verb | good at + V + ing 184. Will not be good |
| 73. Won't help + Who + Verb 74. Can't | at + Verb ing 185. Can be good at + |
| help + Who + Verb 75. Feel + Who + Verb | Verb ing 186. Cannot be good at + V + |
| (Feels + Who + Verb) 76. Felt + Who + | ing 187. Be forced to + Verb (am forced |
| Verb 77. Will feel + Who + Verb 78. Can | to + Verb, is forced to + Verb, are forced |
| feel + Who + Verb 79. Don't feel + Who + | to + Verb) 188. Be not forced to + Verb |
| Verb (doesn't feel + Who + Verb) 80. | (am not forced to + Verb, is not forced |
| Didn't feel + Who + Verb 81. Won't feel + | to + Verb, are not forced to + Verb) 189. |
| Who + Verb 82. Can't feel + Who + Verb | Was/Were forced to + Verb 190. Was |
| 83. Notice + Who + Verb (Notices + Who + | not/Were not forced to + Verb 191. Will |
| Verb) 84. Noticed + Who + Verb 85. Will | be forced to + Verb 192. Can be forced |
| notice + Who + Verb 86. Can notice + Who + | to + Verb 193. Will not be forced to + |
| Verb 87. Don't notice + Who + Verb | Verb 194. Cannot be forced to + Verb |
| (doesn't notice + Who + Verb) 88. Didn't | |
| notice + Who + Verb 89. Won't notice + | |
| Who + Verb 90. Tell + Who to + Verb | |
| (Tells + Who to + Verb) 91. Told + Who to + | |
| Verb 92. Will tell + Who to + Verb 93. | |
| Can tell + Who to + Verb 94. Don't tell + | |
| Who to + Verb (doesn't notice + Who to + | |
| Verb) 95. Didn't notice + Who to + Verb | |
| 96. Won't notice + Who to + Verb 97. Can't | |
| notice + Who to + Verb 98. Watch + Who + | |
| Verb (Watches + Who + Verb) 99. | |
| Watched + Who + Verb 100. Will watch + | |
| Who + Verb 101. Can watch + Who + Verb | |
| 102. Don't watch + Who + Verb 103. Didn't | |
| watch + Who + Verb 104. Will not watch + | |
| Who + Verb 105. Cannot watch + Who + | |
| Verb 106. Force + Who to + Verb (forces + | |
| Who to + Verb) 107. Forced + Who to + | |
| Verb 108. Will force + Who to + Verb 109. | |
| Can force + Who to + Verb 110. Don't | |
| force + Who to + Verb 111. Didn't force + | |
| Who to + Verb 112. Won't force + Who to + | |
| Verb 113. Can't force + Who to + Verb | |
| 114. Have + past participle (pp) (has + pp) | |
| 115. Have not + pp (has not + pp) 116. Had + | |
| pp117. Had not + pp118. Could have + | |
| pp 119. Could not have + pp120. Would | |
| have + pp 121. Would not have + pp 122. | |
| Should have + pp 123. Should not have + | |
| pp 124. Must have + pp 125. Must not have + | |
| pp 126. Might have + pp 127. Might not | |
| have + pp | |

As shown in Table 1, a unit verb 30 corresponding to one specific verb may be modified for at least 194 meanings.

A bare infinitive verb 31 is applied to 180 unit verbs 30 among 194 unit verbs (a past participle verb 33 is only applied to the other 14 unit verbs) so that a learner can easily learn most of the unit verbs 30 with the bare infinitive verb alone. Also, during learning of the unit verbs 30, the bare infinitive verb is repeatedly learned and thus may be naturally memorized.

Since the set of unit verbs 30 is applied to each specific verb, it is preferable to learn the list as one pattern. As a result, a learner who learns the pattern can make various meanings by modifying any given verb and improve his or her vocabulary. Further, the unit verbs 30 made in this way constitute a set of at least one consecutive unit and thus can be immediately expressed without consideration of the order of words. Accordingly, English skills can be improved.

A plurality of unit verbs corresponding to a specific verb may be seen as being arranged in one direction. Alternatively, as shown in FIG. 2, the plurality of unit verbs 30 may be shown in the tree form 301. When the unit verbs 30 are shown in the tree form 301, similar unit verbs 30 having similar expressions may be output to be adjacent to each other.

Otherwise, the unit verbs 30 may be shown in a tree form based on relevant rules (not shown). For example, a unit verb “can't go” is a negative form of “can go” and thus is easily associated with “can go.” Accordingly, when “can't go” is indicated as being subordinate to “can go,” the unit verbs can be memorized more easily, and the bare infinitive verb which is used in a process of memorizing the unit verbs can be repeatedly and naturally learned and stored in long-term memory. The structure of the tree may be customized by a user. Learners may associate different algorithms with memorizing verb expressions. In consideration of this, customization enables each learner to correct the position and connections of each verb expression in the tree form of verb expressions so that verb expressions may be output in a tree form suitable for the learner.

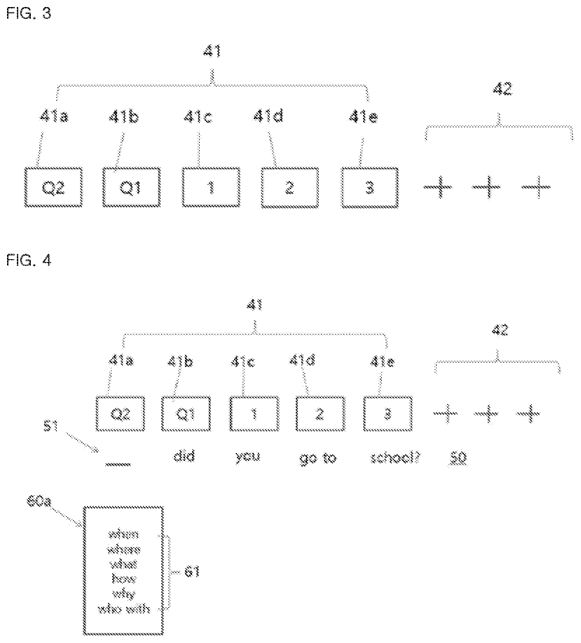

FIG. 3 shows an example of one scene of English learning related to the present invention.

A sentence element indicator 41 may be output in a card form as shown in FIG. 3. When the sentence element indicator 41 is output in a card form, the visibility of a learner is increased, and an immediate idea emerges. To show the form of a specific sentence, a plurality of sentence element indicators 41 are arranged and output in a certain order. In the present invention, the plurality of sequentially arranged sentence element indicators 41 may include a card 41a representing unit interrogatives which mean who, when, where, what, why, how (5W1H) (hereinafter “unit interrogatives”), a card 41b representing verbs and auxiliary verbs used in interrogative sentences (hereinafter “interrogative verbs”), a card 41c representing subjects or all available expressions in a subject form, a card 41d representing verbs or combined forms of verbs (hereinafter “unit verbs”), and a card 41e representing objects or all available expressions in an object form. Additional sentence constituent elements may come behind an object but have no influence on the structure of a general sentence. Accordingly, the sentence element indicators 41 for such additional expressions may be omitted or replaced with another form of mark 42.

More specifically, unit interrogatives may include not only conventional interrogatives, such as “when,” “where,” “what,” “how,” “why,” and “who,” but also combinations of interrogatives and other words such as “who with,” “what+noun,” “how+adjective,” “how many+noun,” and “how much+noun.” Since the three or more types of expressions are consecutively combined with interrogatives and disposed in sentences, it is necessary to memorize the three or more types of expressions as one unit.

Interrogative verbs are verbs which precede subjects in interrogative sentences and include interrogative auxiliary verbs, such as “do,” “does,” “did,” “will,” “can,” “should,” have,” has,” and “had,” and interrogative to be verb such as “am,” “are,” “is,” “was” and “were.”

A sentence form may be a combination of at least some of the five sentence elements. Therefore, when a sentence form is given, it is possible to show a learner how a sentence is made by arranging appropriate sentence element indicators for the given sentence form.

For example, in the case of learning an interrogative sentence including an interrogative, all of the five cards 41a, 41b, 41c, 41d, and 41e may be output as the sentence element indicators 41. In the case of learning a declarative sentence and a negative sentence, the five sentence element indicators may be output excluding the two sentence element indicators 41a and 41b respectively corresponding to a unit interrogative and an interrogative verb.

A subject means a subject in a sentence and may range from “I,” “you,” “he,” and “she” which indicate people to nouns indicating things. In some cases, a subject cannot be only a gerund or a to-infinitive but can also be any form equivalent to a subject.

A learner may rapidly adapt himself or herself to a sentence structure by visually checking such an arrangement of sentence element indicators according to a sentence form.

The sentence element indicators 41 may have marks which enable a learner to know which sentence elements correspond to the sentence element indicators 41. The learner may be aware of which sentence element will or should be at a position by simply checking a corresponding mark. For example, the five sentence element indicators 41a, 41b, 41c, 41d, and 41e may have the marks “Q2,” “Q1,” “1,” “2,” and “3,” respectively. When both the cards 41a and 41b of “Q2” and “Q1” are included, the learner may be aware that the corresponding sentence includes an interrogative. When the card 41a of “Q2” is excluded and the card 41b of “Q1” is included, the learner may be aware that the corresponding sentence is an interrogative sentence without a unit interrogative (not shown).

In embodiments described below, an example case in which the plurality of sentence element indicators 41 are denoted by “Q2,” “Q1,” “1,” “2,” and “3” will be described. However, the sentence element indicators 41 may be denoted by other marks. For example, the five sentence element indicators may be denoted by marks such as “unit interrogative,” “interrogative verb,” “unit verb,” and “object.”

FIG. 4 shows an example of one scene of English learning related to the present invention.

The plurality of sentence element indicators 41 may be output to be sequentially arranged, and a learner may predict a sentence structure through the plurality of sentence element indicators 41. For example, when which of the plurality of sentence element indicators 41 are denoted by “Q2,” “Q1,” “1,” “2,” and “3” are sequentially output, the learner may be aware that the corresponding sentence is an interrogative form including an interrogative.

For learning, an example sentence 50 may be output together with the plurality of output sentence element indicators 41. Here, at least one card in the example sentence 50, that is, a sentence element corresponding to the indicator 41, may be output as a blank 51. For example, an example sentence including a blank may have a form such as “______ did you go to school?” The learner sees that the cards 41a, 41b, 41c, 41d, and 41e of “Q2,” “Q1,” “1,” “2,” and “3” are sequentially output and may be aware that it is necessary to input an expression corresponding to a sentence element corresponding to “Q2” in the blank. Here, the expression to be input corresponds to a single word or a plurality of words.

In this embodiment, an example in which the indicator corresponding to the blank 51 is the “Q2” card 41a is given, but at least one of the other “Q1,” “1,” “2,” and “3” cards 41b, 41c, 41d, and 41e may be an indicator corresponding to the blank 51. Such an indicator corresponding to the blank 51 may be determined according to a preset learning order or the learner's selection.

To input an expression to the blank 51, the learner may select any one expression in an example list 60. In this embodiment, a unit interrogative example list 60a may be “when,” “where,” “what,” “how,” “why,” “who with,” “what+noun,” “how+adjective,” “how many+noun,” and “how much+noun.” The example list 60 may be output by clicking a first card.

Alternatively, expressions 61 of the example list 60 may be sequentially put in the blank and output. For example, when the learner clicks the “Q2” card 41a in which “when” is output, “where,” which may be at the corresponding position instead of “when,” may be output, and then interrogative expressions, such as “what,” may be sequentially output according to an additional input. The learner may learn a sentence including the expressions of the example list 60 which are sequentially input. However, it is preferable for the input expressions to be suitable for the example sentence 50 in terms of form or content. For example, “What did you study English?” cannot be made from “When did you study English?” in terms of meaning. Accordingly, in the corresponding example sentence, “Where” may not be output even when the “Q2” card is continuously clicked. Unlike this, when all the expressions 61 which may be the example list are input, appropriate inputs and inappropriate inputs may be distinguished, and a determination result may be output regarding whether a completed example sentence is appropriate. For example, when the expression “When” is input, the completed example sentence is appropriate in terms of grammar or content, and thus the example sentence 50 may be shown in a green color. When “Where” is input, the completed example sentence is inappropriate in terms of content, and thus the example sentence 50 is shown in a red color to indicate whether the example sentence is appropriate. This is the same for a case in which the expression 61 output in the above-described example list 60 is selected by the learner and input. Whether the completed example sentence is appropriate may be determined according to a determination on whether the completed example sentence corresponds to a pre-stored specific example sentence or may be determined by an algorithm such as machine learning.

Alternatively, the determination result may be output by the learner's personal input without output of the example list 60. Even in this case, as described above, whether the input expression is appropriate for the example sentence in terms of content or form may be determined, and the determination result may be output.

In the embodiments, the sentence element indicators 41 and the example sentence 50 may be output together in parallel.

Alternatively, the blank 51 may be output as a sentence element indicator 41, and the other sentence elements may be output as the example sentence such that the blank 51 and the other sentence elements may be output in series (not shown).

In addition, the interpretation of the example sentence 50 may be output together. This may help the learner with the learning so as to come up with an expression to be input to the blank 51. Alternatively, when the example sentence 50 including an input expression is appropriate, the interpretation may be output such that the learner may finally check the meaning. One advantage of the learning method illustrated in FIG. 4 is that, even when only the position Q2 of a total of six words “when,” “where,” “what,” “how,” “why,” and “who with,” which are 5W1H, corresponding to the “Q2” card 41a is known in the case of making a sentence with a unit interrogative, it is possible to express sentences including up to five unit interrogatives. For example, when the interrogative sentence “when did you study English?” is learned, learning is not finished with the single interrogative sentence. Rather, it is possible to immediately express up to four applied unit interrogatives by simply changing the word “when” corresponding to “Q2” for another word corresponding to 5W1H other than “when.” To the above interrogative sentence, four words “where,” “how,” “why,” and “who with” are easily applied in addition to “when” in terms of learning and make it possible to express interrogative sentences having different meanings.

Here, an important learning point for a learner is that the learner can easily make interrogative sentences having various meanings to which 5W1H are applied by simply changing words corresponding to “Q2” without any changes to an interrogative verb, a subject, a verb, and an object.

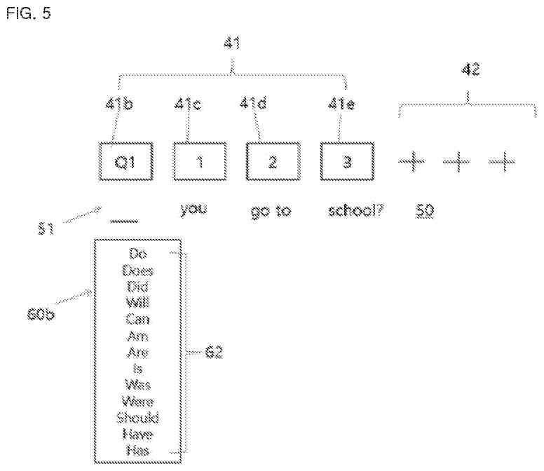

FIG. 5 shows an example of one scene of English learning related to the present invention.

The above-described characteristics can be applied to other sentence forms in the same way. For example, a sentence form corresponding to the “Q1,” “1,” “2,” and “3” cards 41b, 41c, 41e, and 41e without the “Q2” card may be proposed, and expressions to be input to the “Q1” card 41b whose sentence element is an interrogative verb may be learned. In this case, a learner may be aware that the “Q2” card is not present and may expect that learning of an interrogative form without a unit interrogative is performed.

Such a sentence element indicator removal may be performed by stages according to a preset order or performed by the learner's selection. As an example, when the learner deletes the “Q2” card, this may be recognized, and learning of an interrogative form without an interrogative may be performed. A card removal may be performed by executing a delete menu through a touch input on a screen or by dragging and dropping the card to a recycle bin.

Expressions 62 of an example list 60b which may be input to the “Q1” card 41b may be “do,” “does,” “did,” “will,” “can,” “am,” “are,” “is,” “was,” “should,” “have,” “has,” “had,” and the like. As described above, a process of inputting an expression to the “Q1” card 41b may be the learner's selection of a specific expression 62 in the interrogative verb example list 60b, sequential changes of the expressions 62 in the interrogative verb example list 60b, the learner's personal input of an expression, or the like. The learning method also has a learning effect that makes it possible to immediately express as many interrogative sentences as the number of interrogative verbs which may correspond to the “Q1” card 41b with only one declarative sentence formed by arranging the “1,” “2,” and “3” cards in the order of subject, verb, and object. In a declarative sentence, a verb is always the bare infinitive without change, and various sentences are available with a simple change of words corresponding to “Q1.” Accordingly, a declarative sentence is easy and efficient for the learner. For example, in the declarative sentence “you study English.” in which a bare infinitive verb is at the indicator “2,” “Do,” “Does,” “Did,” “Will,” “Can,” and words including auxiliary verbs may be simply used to make various interrogative sentences such as “Do you study English?” or “Did you study English?” according to present, past, future, etc. tenses. Here, an important learning point for a learner is that the learner can easily make interrogative sentences having various meanings by simply changing words corresponding to “Q1” without any changes to a subject, a verb, and an object which constitute a declarative sentence. Also, in a declarative sentence in which “to be verb” is at the indicator “2,” to be verb, such as “am,” “are,” “is,” “was,” and “were,” or words including auxiliary verbs may be used to make various interrogative sentences.

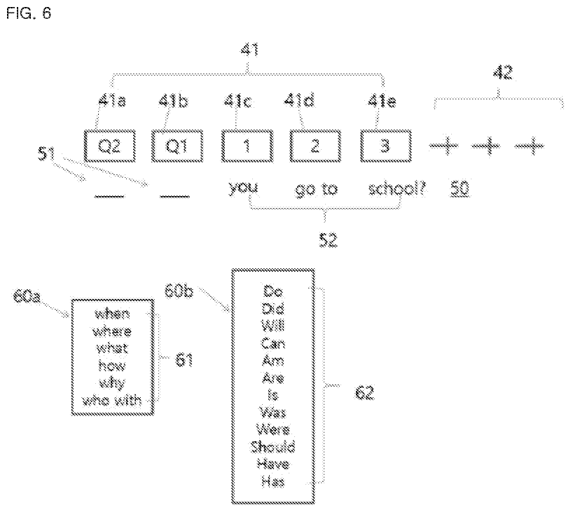

FIG. 6 shows an example of one scene of English learning related to the present invention.

As described above, two or more first cards may correspond to a blank 51 among the plurality of sentence element indicators 41.

For example, when each of the “Q2” card 41a and the “Q1” card 41b is designated as a first card, a blank 51 may be formed to correspond to each of the cards 41a and 41b, and a specific example sentence 52 may be output for the other cards 41c, 41d, and 41e. In this case, corresponding expressions 61 and 62 may be separately input to the “Q2” card 41a and the “Q1” card 41b for learning in the same way as described above.

When there are a plurality of first cards, assuming the same example sentence, it is possible to learn as many combinations as a number obtained by multiplying the number of expressions of the “Q1” example list 60a and the number of expressions of the “Q2” example list 60b.

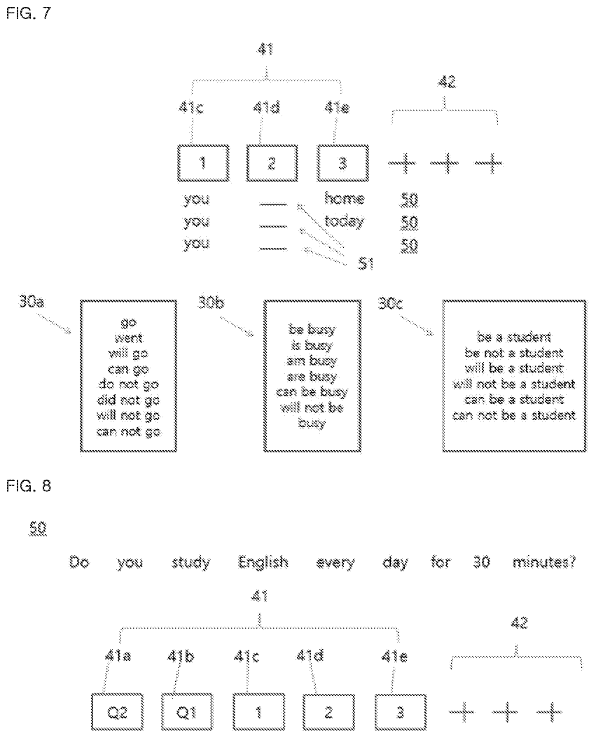

FIG. 7 shows an example of one scene of English learning related to the present invention.

Similar to the above description, in a step of learning the sentence element indicator 41d representing a verb, a sentence element corresponding to the card 41d may be output as a blank 51. Similar to the above-described unit interrogative, not only a verb but also a combination of the verb and another word may be at the position of a verb. Accordingly, these may be collectively considered the concept of a unit verb 30. This has been described in detail with reference to FIG. 2, and thus FIG. 2 will be referred to below for the convenience of description.

For example, the unit verb 30 of “study” may include expressions such as “study,” “studied,” “will study,” “can study,” “do not study,” “did not study,” “will not study,” and “cannot study.” A learner may use such an expression as one unit, that is, a sentence constituent element, for learning.

However, it is unnecessary to store all unit verb expressions each corresponding to one of verbs in a database for storing the unit verb 30. In other words, as shown in Table 1 described above, it is only required to store a list of generalized unit verbs 30 and put a bare infinitive verb 31 or a past participle verb 33 at the position of a verb qualifier or a given specific verb. For example, in the case of “study” and “go,” it is unnecessary to store “will study,” “will go,” “can study,” and “can go” all, and the rules “will+bare infinitive verb” and “can+bare infinitive verb” are stored such that “study” and “go” may be input to each position. However, in an exceptional case in which the rules are changed according to a verb, unit verb expressions may be stored. Here, unit verbs may be classified into some categories and learned. For example, unit verbs may be classified into essential life verbs, basic verbs, colloquial English verbs, slang, etc. and learned according to the classifications.

A unit verb 30 may not only be a unit verb 30a corresponding to a general verb like in the above-described embodiments but may also include a unit verb 30b or 30c corresponding to “to be verb+adjective” or “to be verb+noun.” These unit verbs 30b and 30c may include not only “to be verb+adjective” or “to be verb+noun” but also a verb qualifier 34 or a negative qualifier 35 such as “will,” “can,” and “cannot.” For example, unit verbs 30b corresponding to “be busy,” that is, “to be verb+adjective,” may include not only expressions such as “is busy,” “am busy,” “are busy,” “was busy,” and “were busy” but also expressions such as “will be busy,” “can be busy,” and “will not be busy” to which the verb qualifier 34 or the negative qualifier 35 is added. As another example, unit verbs 30c corresponding to “be a student,” that is, “to be verb+noun,” may include not only expressions such as “is a student,” “am a student,” and “was a student” but also expressions such as “will be a student,” “can be a student,” and “will not be a student” to which the verb qualifier 34 or the negative qualifier 35 is added. However, among example sentences including a unit verb 30b corresponding to “to be verb+adjective” and a unit verb 30c corresponding to “to be verb+noun,” the sentence structure of an interrogative sentence requires modification of a unit verb. For example, when the example sentence “He is busy today” is used, an interrogative sentence in this form may be “Is he busy today?,” “Why is he busy today?,” or the like. In other words, it is necessary to break the form “be busy” which is a unit verb of “busy” applied to a declarative sentence. Therefore, when an adjective forms a unit verb in this way, it is preferable to separately apply the unit verb 30b for a declarative sentence and a unit verb 30 for an interrogative sentence. Even the unit verb 30c corresponding to “to be verb+noun” requires a modification in the same principle as the unit verb 30b corresponding to “to be verb+adjective.”

A learning method which emphasizes the importance of bare infinitive verbs and verbalization skills through learning of verbs and unit verbs in English learning. The learning method enables a learner to learn that declarative sentences and negative sentences are simply obtained through a change in the “2” indicator 41d, which is the position of a verb (including all verb forms such as a unit verb), such that the learner's understanding of English sentence structures can be improved. In other words, it is an important learning point that any declarative sentence sequentially including a subject, a verb, and an object can express various tenses (present, past, and future) thereof through a simple modification or application of the verb without any change to the subject or object, and it is necessary to only modify a verb without any change to a subject or object in the case of changing a declarative sentence to a negative sentence or changing a negative sentence to a declarative sentence.

When a sentence form is a negative sentence or interrogative sentence, patterns of expressions are repeatedly used. In particular, these patterns are classified as a case in which a verb is a general verb, a case in which a verb is a combination of to be verb and an adjective, and a case in which a verb is a combination of to be verb and a noun. These common-use patterns may be output in a form that may be frequently read and referred to by the learner. Table 2 and Table 3 below show an example of the common-use patterns.

TABLE 2
General-use patterns of negative sentences

| General verb | To be Verb + adjective to be verb + noun |
|---|---|
| do not did not will not | be not am not are not is not was not were |
| can not does not | not |

TABLE 3
General-use patterns of interrogative sentences

| General verb | To be Verb + adjective to be verb + noun |
|---|---|
| do did will can does | be am are is was were |

The general-use patterns make it possible to make a sentence with various expressions in the form of a declarative sentence, a negative sentence, and an interrogative sentence and may be more effectively used for English learning in a problem-solving manner. For example, it is assumed that the example sentence “I meet my friends on the weekend” and sentence element indicators corresponding thereto are output and the question “Q. Change the declarative sentence to the negative present tense.” is output. The learner may change the example sentence to a negative present tense through a personal input or may change the example sentence by referring to the above-described “General-use patterns of interrogative sentences.” When the expression “do not” of the referred “General-use patterns of interrogative sentences” is applied to the “2” card, “meet” which is currently output may be modified into “do not meet.” A similar method may be applied to a problem of changing the declarative sentence to an interrogative sentence.

FIG. 8 shows an example of one scene of English learning related to the present invention.

According to the above-described embodiments, while sentence element indicators are output, an expression of an example sentence is input. On the other hand, learning can also be performed by arranging sentence element indicators on the basis of an example sentence without any omitted expression.

For example, an example sentence 50 may be given as “Do you study English every day for 30 minutes?,” and the “Q2,” “Q1,” “1,” “2,” and “3” cards 41a, 41b, 41c, 41d, and 41e may be given to a learner. In this case, the learner may match each expression with the card according to the example sentence 50. Through this process, the learner can review the positions of words in the specified sentence when viewing the sentence and thus develop his or her ability to be aware of the composition and order of a sentence together.

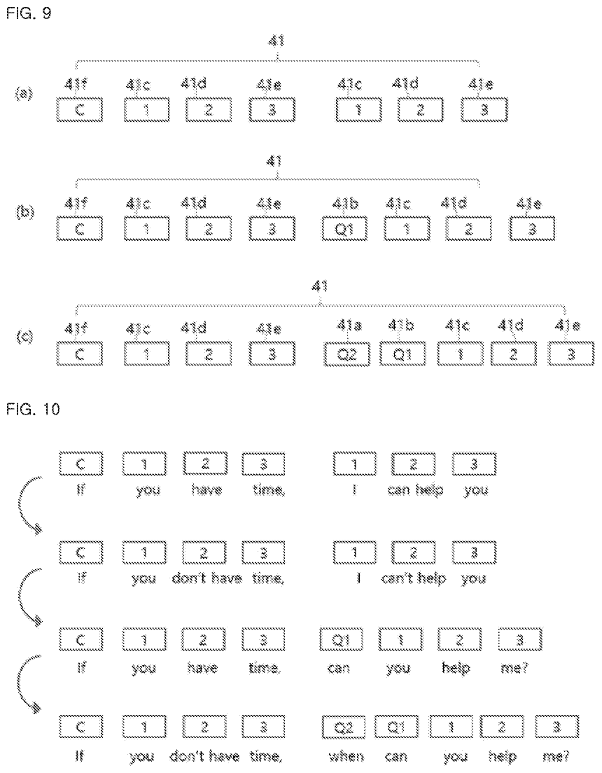

FIGS. 9 and 10 illustrate an embodiment of an English learning method related to the present invention.

Unlike the above embodiments, the English learning method of the present invention may provide learning of a plurality of sentences. A plurality of sentences are generally connected by a conjunction. Like other sentence element indicators 41, a sentence element indicator 41 representing conjunctions may also be output. In particular, the sentence element indicator 41 representing conjunctions may be output in the form of a card 41f representing conjunctions and denoted by, for example, a “C” card. The learner may be aware that the learning is about a sentence in which a plurality of sentences are combined through a conjunction by identifying the “C” card.

“If,” “When,” “Before,” “After,” “Although,” “While,” Because,” etc. may correspond to the card 41f representing conjunctions. These conjunction examples may be output in the form of a list and selected.

Conjunctions may be included in various sentence forms. FIGS. 9A, 9B, and 9C show some forms of sentences including a conjunction. FIG. 9A shows a conjunction+a declarative sentence (or interrogative sentence)+a declarative sentence (or interrogative sentence), FIG. 9B shows a conjunction+a declarative sentence (or interrogative sentence)+an interrogative sentence to which “Q1” is applied, and FIG. 9C shows a conjunction+a declarative sentence (or interrogative sentence)+an interrogative sentence to which “Q2” and “Q1” are applied. In some cases, the order of sentences with and without a conjunction may be reversed.

A learning method using the sentence element indicators 41 may be applied equally within a scope which is not inconsistent with the previous embodiments.

According to the English learning method of this embodiment, it is possible to practice combining two sentences into one sentence using a conjunction.

FIG. 10 shows a learning form of a sentence including a conjunction.

The English learning method of this embodiment corresponds to a practice of constructing a sentence and a sentence unit and thus may be a final learning method encompassing the foregoing other embodiments. Therefore, learning may be performed by changing the form of at least one sentence while maintaining a combined form of a sentence including a conjunction. For example, as shown in FIG. 10, learning may be performed in the order of a first form of a conjunction+a declarative sentence+a declarative sentence, a second form of a conjunction+a negative sentence+a negative sentence, a third form of a conjunction+a declarative sentence+an interrogative sentence, and a fourth form of a conjunction+a negative sentence+an interrogative sentence.

It is possible to learn not only an illustrated sentence but also various forms of example sentences obtained by changing the sentence using the unit verbs included in [Table 1] above.

It is apparent to those of ordinary skill in the art that the present invention can be embodied in other specific forms without departing from the spirit and essential characteristics of the present invention.

In all aspects, the detailed description should not be construed as limiting and should be considered as illustrative. The scope of the present invention should be determined by a reasonable interpretation of the appended claims, and all modifications within the equivalent scope of the present invention are included in the scope of the present invention.

### DESCRIPTION OF SIGNS

11: execution icon

20: tree form of execution list

21: execution list

30: unit verb

30a: unit verb corresponding to general verb

30b: unit verb corresponding to “Be+adjective”

30c: unit verb corresponding to “Be+noun”

301: tree form of unit verbs

31: bare verb

32: past tense verb

33: past participle verb

34: verb qualifier

35: negative qualifier

41: sentence element indicator

41a: card representing unit interrogative

41b: card representing interrogative verb

41c: card representing subject

41d: card representing unit verb

41e: card representing object

41f: card representing conjunction

42: another form of mark

50: example sentence

51: blank

52: example sentence excluding blank

60: example list

60a: unit interrogative example list

60b: interrogative verb example list

61: expression of unit interrogative example list

62: expression of interrogative verb example list

1. A method of providing an English learning service to a user by a server, the method comprising:
outputting a sentence, which is a combination of one or more of sentence elements including a unit interrogative, an interrogative verb, a subject, a unit verb, and an object and includes an interrogative sentence, a negative sentence, or a declarative sentence, using one or more indicators each corresponding to one of the combined sentence elements;
receiving a selection of a specific indicator that the user wants to learn among the one or more indicators from the user;
outputting an example sentence, which includes English expressions corresponding to sentence elements each corresponding to one of the one or more indicators, corresponding to the specific indicator selected by the user together with the one or more indicators, wherein an English expression corresponding to the sentence element of the specific indicator is output as a blank;
outputting an example list for an English expression insertable to the blank to the user together with the example sentence and receiving a specific English expression in the example list from the user; and
outputting a Korean interpretation of a combined sentence, which is obtained by combining the received specific English expression and the example sentence including the blank, to the user, wherein it is determined whether the combined sentence is grammatically correct, the combined sentence is shown in a first color when it is determined that the combined sentence is grammatically correct, and the combined sentence is shown in a second color when it is determined that the combined sentence is grammatically incorrect,
wherein the indicators are displayed together with marks representing what kinds of sentence elements correspond to the indicators so that the user is intuitively aware of which sentence elements will be at corresponding positions,
when a quantity and positions of the combined sentence elements vary according to whether a type of the sentence is an interrogative sentence, a negative sentence, or a declarative sentence, a quantity and positions of the one or more indicators output to correspond to each of the combined sentence elements vary so that the user is aware of the type of the sentence,
an English expression of the example sentence corresponding to the unit interrogative among the sentence elements includes at least one of “when,” “where,” “what,” “how,” “why,” and “who with,”
an English expression of the example sentence corresponding to the interrogative verb among the sentence elements includes any one of “do,” “does,” “did,” “will,” “can,” “am,” “are,” “is,” “was,” “were,” “should,” “have,” “has,” “had” and “auxiliary verb,” and
an English expression of the example sentence corresponding to the unit verb among the sentence elements includes a present tense of a verb, a past tense of the verb, and a past particle of the verb and also includes a combination of the present tense of the verb and one of “will,” “have to,” “can,” “want to,” “do not,” an auxiliary verb, a negative qualifier, a verb-qualifying word, and a verb-qualifying phrase.

2. The method of claim 1, wherein the negative sentence or the declarative sentence provides the learning service only using the unit verb among the sentence elements and the indicator corresponding to the unit verb.

3. The method of claim 1, wherein the receiving of the selection of the specific indicator that the user wants to learn comprises directly receiving a specific verb that the user wants to learn from the user,
the outputting of the example sentence comprises, when the specific verb is input, outputting all unit verbs of the specific verb together with an indicator of the unit verb, and
the unit verb is a word which is locatable at a verb position in the sentence and includes not only a present tense, a past tense, and a past particle of the specific verb but also a combination of the present tense of the verb and any one of an auxiliary verb, a negative qualifier, a verb qualifier, and a verb-qualifying phrase.
